(19) United States
(12) Patent Application Publication
(10) Pub. No.: US 2016/0119868 A1
(43) Pub. Date: Apr. 28, 2016

(54) REDUCING POWER CONSUMPTION IN WIRELESS STATIONS WITH LIMITED MEMORY

(71) Applicant: GainSpan Corporation, San Jose, CA (US)

(72) Inventors: Pankaj Vyas, Bangalore (IN); Vishal Batra, Bangalore (IN)

(21) Appl. No.: 14/522,600

(22) Filed: Oct. 24, 2014

(51) Int. Cl. H04W 52/02; H04W 72/04; H04W 28/02

(52) U.S. Cl. CPC H04W 52/0209; H04W 28/0205; H04W 72/0406; H04W 88/08

(57) ABSTRACT

A wireless station of a wireless network receives, using a receiver, data units from another wireless device in the wireless network. The wireless station stores the data units in a memory contained in the wireless station. The wireless station determines if a current storage level in the memory is greater than a first threshold, and if so, sets the receiver in power savings mode. The wireless station then consumes data units stored in the local memory until the current storage level is lower than a second threshold. The wireless station maintains the receiver in the power savings mode until the current storage level falls below the second threshold. The receiver is then placed in active mode so that the station can receive additional data units for storing in the memory. Power consumption in the wireless station is thereby reduced.

### RELATED APPLICATION

The present application is related to co-pending US application entitled, “Reducing Power Consumption in Wireless Stations Providing Network Connectivity for Embedded Devices”, serial number: unassigned, filed on even date herewith, attorney docket number: GSPN-031-US, naming as Applicants: Pankaj Vyas and Vishal Batra.

### BACKGROUND

1. Technical Field

Embodiments of the present disclosure relate generally to wireless stations, and more specifically to reducing power consumption in wireless stations with limited memory.

2. Related Art

A wireless station refers to an end station of a wireless network. In one common scenario, wireless stations rely on access points as switching devices for transporting packets from one wireless station to another wireless station. Thus, wireless stations are the end points of (potentially multi-hop) communication based on wireless medium.

There are many situations in which it is desirable to reduce power consumption in wireless stations. Aspects of the present disclosure are directed to reducing power consumption in wireless stations with limited memory.

### BRIEF DESCRIPTION OF THE VIEWS OF DRAWINGS

Example embodiments of the present invention will be described with reference to the accompanying drawings briefly described below.

FIG. 1 is a block diagram of an example environment in which several aspects of the present disclosure may be implemented.

FIG. 2 is a flow chart illustrating the manner in which power consumption in a wireless station with limited memory is reduced, in an embodiment.

FIG. 3A is a diagram showing the state of a memory when the storage level in the memory equals a first threshold, in an embodiment.

FIG. 3B is a diagram showing the state of a memory when the storage level in the memory equals a second threshold, in an embodiment.

FIG. 4 is a timing diagram illustrating the interaction between a wireless station and an access point in reducing power consumption in the wireless station, in an embodiment.

FIG. 5 is a block diagram illustrating the implementation details of a wireless station in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present disclosure, a wireless station of a wireless network receives, using a receiver, data units from another wireless device in the wireless network. The wireless station stores the data units in a memory contained in the wireless station. The wireless station determines if a current storage level in the memory is greater than a first threshold, and if so, sets the receiver in power savings mode. The wireless station then consumes data units stored in the local memory until the current storage level is lower than a second threshold. The wireless station maintains the receiver in the power savings mode until the current storage level falls below the second threshold. The receiver is then placed in active mode so that the station can receive additional data units for storing in the memory.

Power consumption in the wireless station is thereby reduced. In an embodiment, the wireless station is designed to operate according to the IEEE 802.11 (WLAN) standards, and the wireless network is a WLAN network.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

2. Example Environment

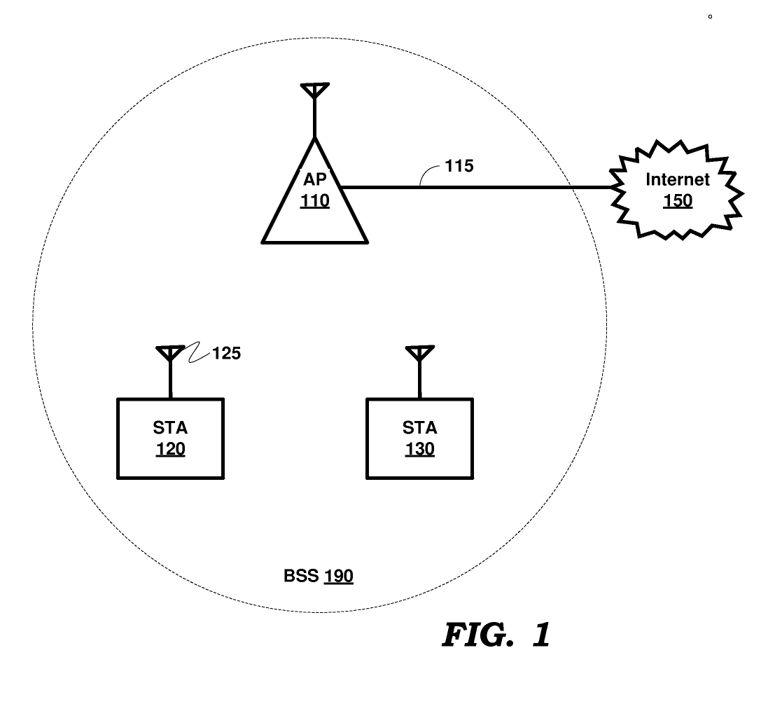

FIG. 1 is a block diagram representing an example environment in which several aspects of the present disclosure can be implemented. The example environment is shown containing only representative devices and systems for illustration. However, real world environments may contain more or fewer systems. FIG. 1 is shown containing access point (AP) 110, wireless stations (STA) 120 and 130, and internet 150. AP 110 and STAs 120 and 130 are generically referred to herein as wireless devices. STA 120 is shown containing antenna 125. AP 110 and STA 130 are also shown containing antennas, but not numbered. Although, only two STAs are shown, the environment of FIG. 1 may contain more or less than two STAs also. Further, in the description below, the devices and the environment are described as operating consistent with Wireless Local Area Network (WLAN) according to IEEE 802.11 standard(s), merely for illustration Implementations in other environments are also contemplated to be within the scope and spirit of various aspects of the present invention.

Internet 150 extends the connectivity of wireless stations 120 and 130 to various systems (not shown) connected to, or part of, internet 150. Internet 150 and is shown connected to access point (AP) 110 through a wired path 115. STAs 120 and 130 may access devices/systems in internet 150 via AP 110. Internet 150 may be implemented using protocols such as IP. In general, in IP environments, an IP packet is used as a basic unit of transport, with the source address being set to the IP address assigned to the source system from which the packet originates and the destination address set to the IP address of the destination system to which the packet is to be eventually delivered. The IP packet is encapsulated in the payload of layer-2 packets when being transported across WLANs.

An IP packet is said to be directed to a destination system when the destination IP address of the packet is set to the IP address of the destination system, such that the packet is eventually delivered to the destination system. When the packet contains content such as port numbers, which specifies the destination application, the packet may be said to be directed to such application as well. The destination system may be required to keep the corresponding port numbers available/open, and process the packets with the corresponding destination ports.

Each of STAs 120 and 130 represent end stations, and may be the source or destination (i.e., consumer) of data packets (data units). STAs 120 and 130 may correspond to devices such as, for example, mobile phones, personal digital assistants (PDA), laptop computers, audio/video player, etc. AP 110 represents a switching device, and forwards data packets received from one STA to the other STA. AP 110 also forwards data packets received from any of the STAs and destined for a device(s) in internet 150. AP 110 may receive data packets from internet 150 and forward the data packets to the corresponding destination STA(s). Further, AP 110 may perform various other operations consistent with IEEE 802.11 (WLAN) standards, as is well known in the relevant arts.

Block 190, shown containing AP 110 and STAs 120 and 130, represents a basic service set (BSS) of an infrastructure mode wireless network consistent with the IEEE 802.11 standard. Although only a single BSS is shown and described, other environments may include more than one BSS, with the BSSs being interconnected to form an extended service set (ESS) consistent with IEEE 802.11 standards, as is well known.

One or both of STAs 120 and 130 may execute user applications as desired. It may be desirable to reduce power consumption in wireless stations such as STA 120 and STA 130 when executing such user applications, as described next with respect to a flowchart.

### 3. Reducing Power Consumption

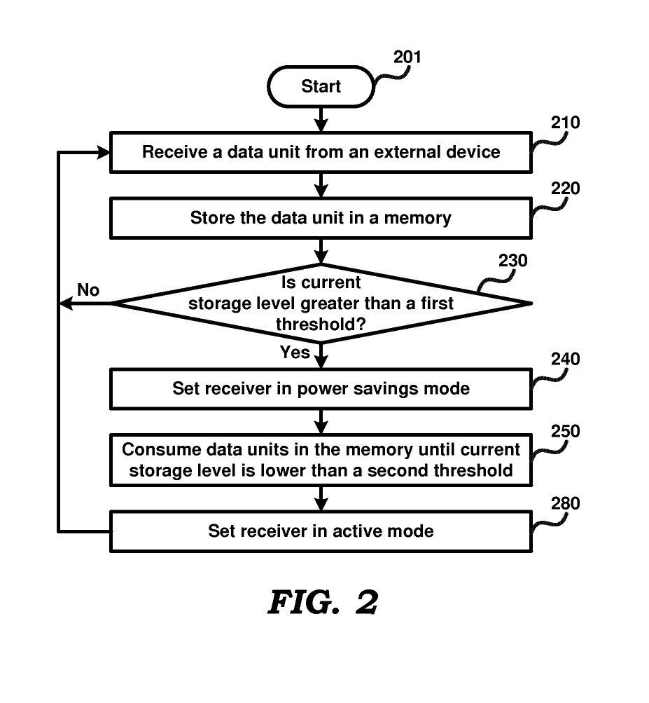

FIG. 2 is a flow chart illustrating the manner in which power consumption in a wireless station with limited memory is reduced, in an embodiment of the present disclosure. Merely for illustration, the flowchart is described below as being performed in STA 120 when STA 120 receives data units from an external device (either in BSS 190 or internet 150). However, the features can be implemented in STA 130, as well as in other systems and environments without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, STA 120 receives a data unit from an external device. With respect to FIG. 1, for example, the external device corresponds to AP 110. The data unit may have originated at STA 130 or a device in internet 150. A receiver in STA 120 designed to operate according to IEEE 802.11 (WLAN) standards to receive the data unit may be maintained in an active state, or at least switched to the active state (powered-ON state), to receive the data unit. Control then passes to step 220.

In step 220, STA 120 stores the received data unit in a memory. The memory may be either local (internal) to STA 120 or external (but readily accessible) to STA 120. Control then passes to step 230.

In step 230, STA 120 determines if a current storage level in the memory is greater than a first threshold. The term “current storage level” refers to the number of memory locations (bytes, words, etc.) that ‘currently’ have valid data units (including the data units received in step 210) stored in them. If the current storage level is not greater than the first threshold, control passes to step 210, and STA 120 receives another data unit from the external device, and the corresponding steps may be repeated till the current storage level exceeds the first threshold. If the current storage level is greater than (exceeds) the first threshold, control passes to step 240.

In step 240, STA 120 sets the receiver (used to receive the data units, as in step 210) to power savings mode. As used herein, the term ‘receiver’ refers to those hardware portions of STA 120 (excluding antenna 595) that are used to receive a WLAN signal and demodulate the WLAN signal to extract data/control information in the WLAN signal. Depending on the specific implementation, the receiver may include circuitry to perform down-conversion of a WLAN RF signal, analog-to-digital conversion, sampling, baseband processing, etc, as is well known in the relevant arts. When set to power savings mode, power to some or all of the circuitry (hardware portions) of the receiver is turned OFF. In some implementations of STA 120, some of the receiver's operations (e.g., some or all baseband operations) may be performed by a processing block. In such implementations, the corresponding portion of the processing block may also be powered down, and/or the corresponding software instructions may not be executed. Control then passes to step 250.

In step 250, STA 120 consumes data units in the memory until the current storage levels falls below a second threshold. Consumption of data units refers to the processing of the data units such that the processed data units in the memory are no longer needed to be stored in the memory. For example, an audio player (e.g., of a user application) in STA 120 may retrieve data units representing the corresponding portion of the song, process and convert the data unit to an analog signal and provide the analog signal to a speaker. The processed/rendered/used data units are no longer needed in the memory, and are deemed to have been consumed (thereby making the corresponding memory locations available for storing of other data units). Control then passes to step 280.

In step 280, STA 120 sets the receiver in active mode. Active mode refers to an operating mode, in which the RF as well as baseband portions are powered ON (with clock gating to baseband removed if earlier applied), and thus enabled to receive and process WLAN signals, and extract data/information from the WLAN signals. Control then passes to step 210, and the corresponding steps of the flowchart of FIG. 2 may be repeated.

It is noted here, the specific sequence of the steps described above are provided by way of illustration only. In operation, two or more of the steps may be concurrently performed in STA 120. For example, the combination of steps 210 and 220 may be executed by a first execution thread, the combination of steps 230, 240 and 280 may be executed by a second execution thread, while step 250 may be executed as a third execution thread. The first execution thread, the second execution thread and the third execution thread may be executed concurrently.

Thus, according to an aspect of the present disclosure, whether a receiver is operated in the active mode or in power savings mode is based on the amount of memory space ‘currently’ available (i.e., free) for storing data units received via the receiver. The total memory space available, and therefore the current amount of free memory, may be limited (small) at least in relation to the total volume of data units to be received, stored and consumed by STA 120. Further, STA 120 may not be able to consume the received data units at least at the rate the data units are received from memory.

Therefore, using the current storage level of the memory as a measure to control reception of data units by operating the receiver in active mode, and to stop reception of data units by operating the receiver in power savings mode, may enable reduction of power consumption in STA 120, as well as avoiding retransmission of data packets from AP 110 (based on request for such retransmission from STA 120 due to data overflow in the local memory).

As an example, and also as noted above, STA 120 may represent a mobile phone or an audio/video player, and may be used to play/render songs, video, etc. Accordingly, STA 120 may download data units representing such audio/video files via AP 110 from another device in BSS 190 or a device in internet 150. STA 120 may have limited memory to store (buffer) the data units. Further, the rate at which STA 120 consumes the data units in playing the song/video may be slower than the rate at which the data units are received from AP 110. Therefore, operating the WLAN receiver of STA 120 as described above with respect to the steps of flowchart of FIG. 2 may provide the benefits noted above.

The operations of the steps of the flowchart of FIG. 2 are further illustrated below with respect to a timing diagram. However, the implementation details of a wireless station in an embodiment of the present disclosure are provided next.

### 4. Example Implementation

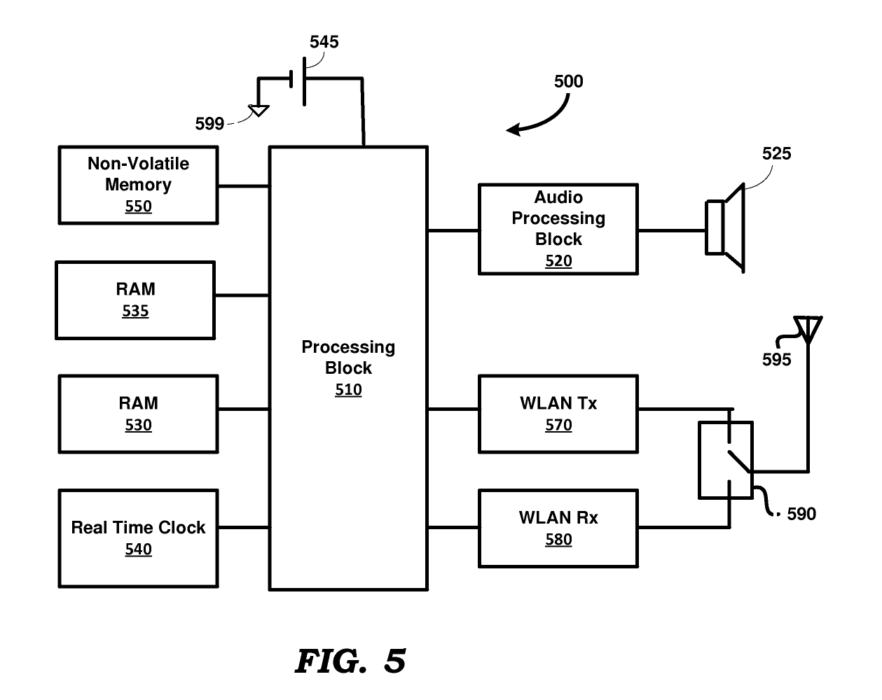

FIG. 5 is a block diagram showing the implementation details of a wireless station in an embodiment of the present disclosure. Wireless device 500 may correspond to any of STAs 120 and 130 of FIG. 1. However, in the following description, it is assumed that wireless device 500 corresponds to STA 120. Accordingly, STA 120 is shown containing processing block 510, audio processing block 520, speaker 525, random access memory (RAM) 530, random access memory (RAM) 535, real-time clock (RTC) 540, battery 545, non-volatile memory 550, WLAN transmitter (Tx) 570, WLAN receiver (Rx) 580, switch 590, and antenna 595. The whole of STA 120 may be implemented as a system-on-chip (SoC), except for battery 545 and antenna 595. Alternatively, the blocks of FIG. 5 may be implemented on separate integrated circuits (IC).

Battery 545 provides power for operation of STA 120, and may be connected to the various blocks shown in FIG. 5. Although not shown in FIG. 5, STA 120 may contain corresponding circuitry (such as power switches, for example) for selectively powering-ON and powering-OFF WLAN Rx 580, and (optionally) WLAN Tx 570 also. When STA 120 operates in power savings mode, the drain on (rate of discharge of) battery 545 is reduced, thereby reducing power consumption in STA 120. RTC 540 operates as a clock, and provides the ‘current’ time to processing block 510. Terminal 599 represents a ground terminal.

Antenna 595 operates to receive from, and transmit to, a wireless medium, corresponding wireless signals according to IEEE 802.11 (WLAN) standards. Switch 590 may be controlled by processing block 510 (connection not shown) to connect antenna 595 to one of blocks 570 and 580 as desired, depending on whether transmission or reception of WLAN signals is required. Switch 590, antenna 595 and the corresponding connections of FIG. 5 are shown merely by way of illustration. Instead of a single antenna 595, separate antennas, one for transmission and another for reception of WLAN signals, can also be used. Various other techniques, well known in the relevant arts, can also be used instead.

WLAN Tx 570 receives data to be transmitted according to WLAN standards from processing block 510, generates a modulated radio frequency (RF) signal according to IEEE 802.11 standards, and transmits the RF signal via switch 590 and antenna 595. WLAN Tx 570 may contain RF and baseband circuitry for generating and transmitting WLAN signals, as well as for medium access operations. Alternatively, WLAN Tx 570 may contain only the RF circuitry, with processing block 510 performing the baseband and medium access operations (in conjunction with the RF circuitry).

WLAN Rx 580 represents a ‘receiver’ that receives an RF signal (according to IEEE 802.11/WLAN standards) bearing data and/or control information via switch 590, and antenna 595, demodulates the RF signal, and provides the extracted data or control information to processing block 510. WLAN Rx 580 may be implemented according to one of several well known approaches. Thus, for example, WLAN Rx 580 may contain RF as well as baseband processing circuitry for processing a WLAN signal. Alternatively, WLAN Rx 580 may contain only the RF circuitry, with processing block 510 performing the baseband operations in conjunction with the RF circuitry. WLAN Rx 580 may selectively be powered OFF (e.g., in power savings mode) and powered ON (e.g., in active mode) by controlling (by processing block 510, for example) corresponding circuitry, such as power switches (not shown), connecting WLAN Rx 580 to battery 545. Further, when WLAN Rx 580 includes baseband processing circuitry, such circuitry may also be selectively powered OFF (in power savings mode) and powered ON (in active mode). Alternatively, the master clock provided for operation of such baseband circuitry may be capable of being gated OFF and gated ON by corresponding circuitry.

Audio processing block 520 receives, from processing block 510, data units that have been received by STA 120 from an external device (as described above with respect to step 210 of FIG. 2), and stored (buffered) in RAM 530. It is assumed here merely for illustration that the data units received from an external device and processed according to the flowchart of FIG. 2 represent audio information (songs, voice messages, etc.). Audio processing block 520 may process the data units (including digital to analog conversion, filtering, etc.), and provides the resulting analog signal to speaker 525, which plays the audio/speech signal.

Non-volatile memory 550 is a non-transitory machine readable medium, and stores instructions, which when executed by processing block 510, causes STA 120 to operate as described above. In particular, the instructions enable STA 120 to operate as described with respect to the flowchart of FIG. 2, when implemented correspondingly.

RAM 530 is a volatile random access memory, and may be used for storing instructions and data. RAM 535 is a volatile random access memory is used for storing data units received from an external device, and processing block 510 may retrieve and consume such data units as described with respect to the flowchart of FIG. 2. A separate memory (RAM 535) is noted as being used for storing data units received from an external device, merely to simplify description. However, such data units can also be stored in RAM 530 or some other type of memory (e.g., Flash). When RAM 530 is used, one set of contiguous portions of memory locations of RAM 530 may be used for storing the received data units, while another set of contiguous portions of memory locations of RAM 530 may be used for storing instructions and data.

Processing block 510 (or processor in general) may contain multiple processing units internally, with each processing unit potentially being designed for a specific task. Alternatively, processing block 510 may contain only a single general-purpose processing unit. Processing block 510 may execute instructions stored in non-volatile memory 550 or RAM 530 to enable device 500 to operate according to several aspects of the present disclosure, described above in detail. Processing block 510 may issue control signals to selectively power-ON/power-OFF WLAN Rx 580 according to the operations noted with respect the flowchart of FIG. 2. Processing block 510 may also issue control signals to signals selectively power-ON/power-OFF WLAN Tx 570 also. In some implementations of STA 120, processing block 510 may perform some operations (e.g., some or all baseband operations) related to receipt and demodulation of WLAN signals, as well as other operations such as decryption, error corrections, etc. In such implementations, the corresponding portion(s) of processing block 510 may be powered down, and/or the corresponding software instructions may not be executed in the power savings mode. In such implementations, the term ‘receiver’ as used herein refers to the combination WLAN Rx 580 and the corresponding portion(s) of processing block 510.

When the received data units represent audio data, processing block 510 may retrieve data units stored in RAM 535, and forward the data units to audio processing block 520. A multi-processing/multi-thread environment may be implemented using non-volatile memory 550, RAM 530, and processing block 510 and corresponding software instructions, to perform the steps of the flowchart of FIG. 2.

RAM 530 and non-volatile memory 550 (which may be implemented in the form of read-only memory/ROM/Flash) constitute computer program products or non-transitory machine (or computer) readable medium, which are means for providing instructions to processing block 510. Thus, such medium can be in the form of removable (floppy, CDs, tape, etc.) or non-removable (hard drive, etc.) medium. Processing block 510 may retrieve the instructions, and execute the instructions to provide several features of the present disclosure.

The description is continued with respect to a timing diagram illustrating the manner in which power is reduced in the receiver of STA 120, in an embodiment.

### 5. Timing Diagram

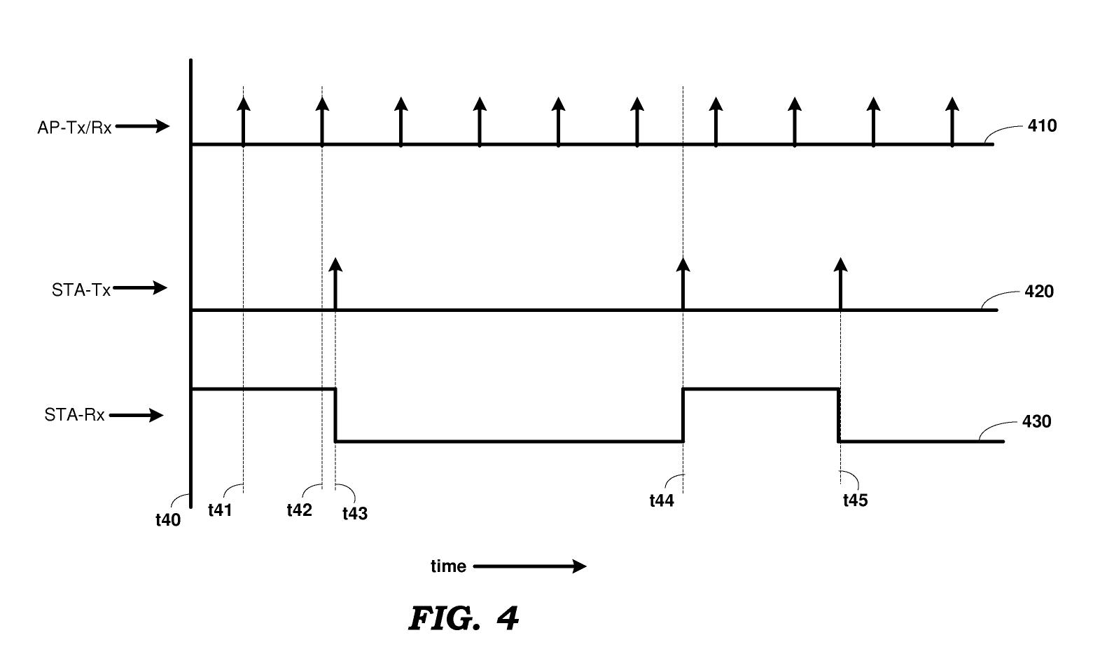

FIG. 4 is a timing diagram used to illustrate the manner in which power consumption in a STA is reduced, in an embodiment of the present disclosure. The waveforms of FIG. 4 may not be to scale. Waveform 410 (AP-Tx/Rx) represents transmissions and receptions of WLAN signals by/at AP 110 (of FIG. 1).Waveform 420 (STA-Tx) represents transmissions of WLAN signals from WLAN Tx 570. Waveform 430 represents the operational state (active mode and power savings modes) of WLAN Rx 580.

It is assumed in the following description that STA 120 has associated and authenticated with AP 110 sometime prior to time instance t40. Also, it is assumed that STA 120 has synchronized its local clock (maintained in RTC 540) with a master clock maintained in AP 110. Further, it is assumed that STA 120 has negotiated a listen interval in cooperation with AP 110, also prior to t40. The listen interval represents the maximum duration for which AP 110 can locally (within AP 110) buffer unicast data destined for STA 120.

In a typical operating scenario, once a STA has set its receiver to power savings mode, the STA powers ON the receiver at least once before the expiry of the listen interval, to ensure that unicast data destined for the STA is not lost. However, according to an aspect of the present invention, the power save mode duration and active mode duration (as well as their start and end time instances) of WLAN Rx 580 are determined based on the current storage level in RAM 535 as illustrated below.

The vertical arrows of waveform 410 represent start of beacon transmissions from AP 110. Thus, the interval t41-t42 represents a beacon interval of AP 110. In the interval t40-t43, WLAN Rx 580 is maintained in the active mode (power ON state), and receives data units (step 210) from AP 110. STA 120 stores the data units (step 220) in RAM 535. Concurrently with the receiving and storing of the data units, processing block 510 (in conjunction with audio processing block 520) consumes the data units (step 250). Thus, processing block 510 may retrieve the data units from RAM 535, and forward the data units to audio processing block 520, which may in turn process the data units suitably, as described above.

Concurrently with the operations of receiving the data units, storing the data units, and consuming the data units, processing block 510 determines (at corresponding intervals) if the current storage level in RAM 535 is greater than a first threshold.

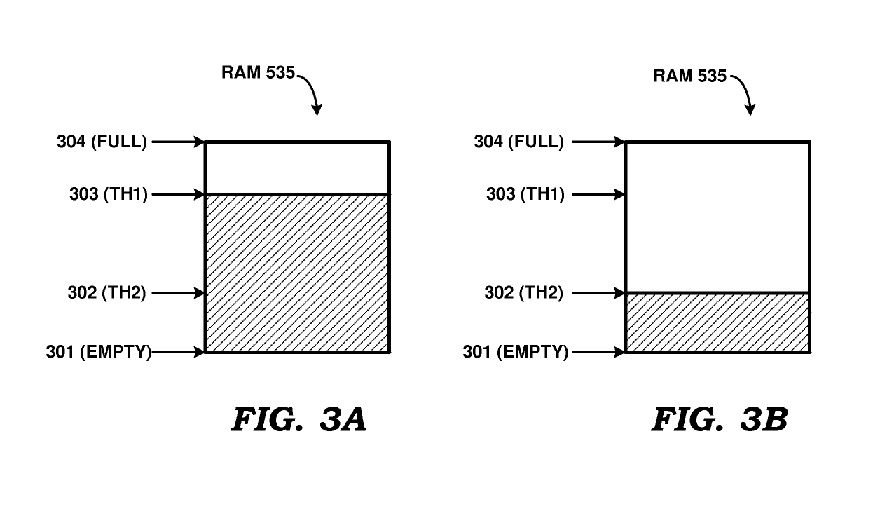

FIG. 3A is a diagram depicting RAM 535, and the current storage level in RAM 535. As shown there, level 301 indicates a zero/empty storage level (no data currently stored), and level 304 indicates full storage level. The hashed part of the block depicting RAM 535 indicates the current storage level, which is shown in FIG. 3A as equaling a first threshold TH1(303). Thus, if a current iteration of steps 210 and 220 leads to the current storage level being determined as greater than TH1, STA 120 sets WLAN Rx 580 (receiver, in general) in the power savings mode (step 240). With respect to FIG. 4, processing block 510 makes a determination that the current storage level in RAM 535 exceeds THI at time instance t43, and therefore sets/places WLAN Rx 580 (or receiver, in general) in power savings mode at t43. The specific value of THI (as a percentage of the full storage level 304) may be preconfigured by a user.

At (or slightly earlier than) t43, WLAN Tx 570 (under control from processing block 510) transmits a NULL frame (indicated by vertical arrow of waveform 420 at t43) to AP 110, with the power management (PM) bit in the NULL frame set to a value one, indicating that STA 120 is to set WLAN Rx 580 in power savings mode. In response to receipt of the NULL frame, AP 110 commences buffering unicast data destined for STA 120.

In the interval t43-t44, AP 110 buffers data units destined for STA 120. In the interval t43-t44 STA 120 (or processing block 510 in conjunction with audio processing block 520) consumes data stored in RAM 530, until the storage level falls below a second threshold (TH2)(step 250). FIG. 3B shows a state of RAM 530, in which the current storage level equals TH2. Thus, when a next data unit is consumed by the operation of step 250, the current storage level would fall below TH2, and STA 120 sets WLAN Rx 580 (receiver, in general) in the active mode (step 580). The specific value of TH2 (as a percentage of the full storage level 304) may be preconfigured by a user.

At (or slightly later than t44), STA 120 sets/places WLAN Rx 580 (or receiver in general) in the active mode, and WLAN Tx 570 transmits a NULL frame (indicated by vertical arrow of waveform 420 at t44) to AP 110, with the power management (PM) bit in the NULL frame being set to a value zero, indicating that STA 120 has set WLAN Rx 580 in the active mode and that AP 110 need not buffer data destined for STA 120.

In response to receipt of the NULL frame with PM bit set to value zero, AP 110 transmits the data units (buffered in AP 110 in the interval t43-t44) to STA 120. The data units may have been received by AP 110 in the interval t43-t44 from STA 130 or from a device in internet 150.

In the interval t44-t45, STA 120 receives the data units transmitted by AP 110 via WLAN Rx 580 (now in active mode), and stores the data units in RAM 535. It is noted that STA 120 may concurrently consume the data units.

At, or slightly earlier than t45, it is assumed that the current storage level in RAM 530 again exceeds TH1. In response, STA 120 sets WLAN Rx 580 to power savings mode, and the operations illustrated in the timing diagram of FIG. 4 may repeat.

In an embodiment, a circular buffer is maintained in RAM 535 for storing received data unit. A corresponding processing thread, executed by processing block 510, determines at corresponding (frequent) intervals the current storage level of the circular buffer (step 230), and performs the steps of 240 and 280 as appropriate. A second separate processing thread may be used for performing steps 210 and 220, while a third separate processing thread may be used for performing step 250. The three processing threads may execute concurrently in a multi-thread/multi-processing environment using processing block 510 and corresponding software instructions.

It is noted that due to the setting of WLAN Rx 580 in power savings and if the t43-t44 interval is greater than the listen interval of STA 120, some data units destined for STA 120 could potentially be lost due to AP 110 discarding the data units. In such instances, STA 120 may execute higher level protocols such as TCP (transmission Control Protocol) retries to recover the lost data units.

It is also noted that STA 120 may negotiate a large value for the listen interval (e.g., of the order of several seconds) during the association with AP 110, and rely on the current storage level in RAM 535 to determine whether WLAN Rx 580 should operate in the power savings mode or active mode, each of which may typically be smaller than the listen interval.

### 6. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of operating a wireless device of a wireless network, said method being performed in said wireless device, said method comprising:
receiving a data unit from a second wireless device in said wireless network, a receiver of said wireless device being used to perform said receiving;
storing said data unit in a memory comprised in said wireless device;
determining, at a first time instance, if a current storage level in said memory is greater than a first threshold; and
if said determining determines that said current storage level is greater than said first threshold, then:
setting said receiver in power savings mode;
consuming data units in said local memory until said current storage level is lower than a second threshold; and
maintaining said receiver in said power savings mode until said current storage level is lower than said second threshold.

2. The method of claim 1, wherein said first threshold is different from said second threshold, said method further comprising:
monitoring said current storage level;
ascertaining, at a second time instance later than said first time instance, that said current storage level is lower than said second threshold; and
setting said receiver in an active mode upon said ascertaining.

3. The method of claim 2, wherein said wireless device and said second wireless device are respectively a wireless station (STA) and an access point (AP) according to IEEE 802.11 standards.

4. The method of claim 3, wherein said STA transmits an indication to said AP indicating that said receiver is to be set to said power savings mode upon determining that said current storage level is greater than said first threshold,
wherein, in response to receiving said indication, said AP commences buffering data units destined for said STA.

5. The method of claim 4, wherein said STA transmits another indication to said AP indicating that said receiver has been set to said active mode upon said ascertaining, said STA thereafter resuming said receiving, said storing and said determining,
wherein, in response to receiving said another indication, said AP stops buffering data units destined for said STA.

6. The method of claim 5, wherein each of said indication and said another indication are indicated by a logic one and a logic zero respectively of a power management bit of a NULL frame transmitted by said STA to said AP.

7. The method of claim 2, wherein said consuming is performed concurrently with said receiving, said storing, said determining, and said ascertaining.

8. A wireless device of a wireless network, said wireless device comprising:
a transmitter;
a receiver;
a memory; and
a processor operable to perform the actions of:
receiving through said receiver a data unit from a second wireless device in said wireless network;
storing said data unit in said memory;
determining, at a first time instance, if a current storage level in said memory is greater than a first threshold; and
if said determining determines that said current storage level is greater than said first threshold, then:
setting said receiver in power savings mode;
consuming data units in said local memory until said current storage level is lower than a second threshold; and
maintaining said receiver in said power savings mode until said current storage level is lower than said second threshold.

9. The wireless device of claim 8, wherein said first threshold is different from said second threshold, said processor is further operable to perform the actions of:
monitoring said current storage level;
ascertaining, at a second time instance later than said first time instance, that said current storage level is lower than said second threshold; and
setting said receiver in an active mode upon said ascertaining.

10. The wireless device of claim 9, wherein said wireless device and said second wireless device are respectively a wireless station (STA) and an access point (AP) according to IEEE 802.11 standards,
wherein each of said transmitter and said receiver is designed to operate consistent with the IEEE 802.11 standards.

11. The wireless device of claim 10, wherein said STA transmits, through said transmitter, an indication to said AP indicating that said receiver is to be set to said power savings mode upon determining that said current storage level is greater than said first threshold,
wherein, in response to receiving said indication, said AP commences buffering data units destined for said STA.

12. The wireless device of claim 11, wherein said STA transmits, through said transmitter, another indication to said AP indicating that said receiver has been set to said active mode upon said ascertaining, said processor thereafter resuming said receiving, said storing and said determining,
wherein, in response to receiving said another indication, said AP stops buffering data units destined for said STA.

13. The wireless device of claim 12, wherein each of said indication and said another indication are indicated by a logic one and a logic zero respectively of a power management bit of a NULL frame transmitted by said transmitter to said AP.

14. The wireless device of claim 9, wherein said processor performs said consuming concurrently with said receiving, said storing, said determining, and said ascertaining.

15. A non-transitory machine readable medium storing one or more sequences of instructions for operating a wireless device of a wireless network, wherein execution of said one or more instructions by one or more processors contained in said wireless device enables said wireless device to perform the actions of:
receiving a data unit from a second wireless device in said wireless network, a receiver of said wireless device being used to perform said receiving;
storing said data unit in a memory comprised in said wireless device;
determining, at a first time instance, if a current storage level in said memory is greater than a first threshold; and
if said determining determines that said current storage level is greater than said first threshold, then:
setting said receiver in power savings mode;
consuming data units in said local memory until said current storage level is lower than a second threshold; and
maintaining said receiver in said power savings mode until said current storage level is lower than said second threshold.

16. The non-transitory machine readable medium of claim 15, wherein said first threshold is different from said second threshold, said non-transitory machine readable medium further comprising instructions for enabling said wireless device to perform the actions of:
monitoring said current storage level;
ascertaining, at a second time instance later than said first time instance, that said current storage level is lower than said second threshold; and
setting said receiver in an active mode upon said ascertaining.

17. The non-transitory machine readable medium of claim 16, wherein said wireless device and said second wireless device are respectively a wireless station (STA) and an access point (AP) according to IEEE 802.11 standards.

18. The non-transitory machine readable medium of claim 17, wherein said STA transmits an indication to said AP indicating that said receiver is to be set to said power savings mode upon determining that said current storage level is greater than said first threshold,
wherein, in response to receiving said indication, said AP commences buffering data units destined for said STA.

19. The non-transitory machine readable medium of claim 18, wherein said STA transmits another indication to said AP indicating that said receiver has been set to said active mode upon said ascertaining, said STA thereafter resuming said receiving, said storing and said determining,
wherein, in response to receiving said another indication, said AP stops buffering data units destined for said STA.

20. The non-transitory machine readable medium of claim 19, wherein each of said indication and said another indication are indicated by a logic one and a logic zero respectively of a power management bit of a NULL frame transmitted by said transmitter to said AP.
